(19) United States
(12) Patent Application Publication
(10) Pub. No.: US 2008/0120100 A1
(43) Pub. Date: May 22, 2008

(54) Method For Detecting Target Sound, Method For Detecting Delay Time In Signal Input, And Sound Signal Processor

(76) Inventors: Kazuya Takeda, Nagoya-shi (JP); Kiyoshi Tatara, Nagoya-shi (JP); Fumitada Itakura, Nagoya-shi (JP)

Correspondence Address: KEATING & BENNETT, LLP, 8180 GREENSBORO DRIVE, SUITE 850, MCLEAN, VA, 22102, US

(21) Appl. No.: 10/509,520

(22) PCT Filed: Mar. 17, 2004
(86) PCT No.: PCT/JP04/03524

§ 371 Date: Jun. 8, 2005

(30) Foreign Application Priority Data
Mar. 17, 2003 (JP) 2003-072451

(51) Int. Cl. G10L 21/02

(52) U.S. Cl. 704/233; 704/E21.004

(57) ABSTRACT

A sound signal processor includes first and second framing sections, first and second frequency analyzing sections, and a cross-spectrum calculating sections, for detecting the phase of a cross-spectrum between the sound signals input to first and second microphones, a phase extracting sections, a phase unwrap processing sections, a frequency band dividing section, and first through N-th inclination calculating sections, for detecting the inclinations of the phase of the cross-spectrum detected by the cross-spectrum calculating section with respect to the frequency, and a histogram calculating section and a voiced/voiceless determining section, for detecting a speech section in the sound received by the first and second microphones based on the inclination with respect to the frequency detected by the first through N-th inclination calculating sections.

### BACKGROUND OF THE INVENTION

1. Field of the Invention

The present invention relates to a method for detecting a target sound and a program therefor, a method for detecting a delay time in signal input between sound signals input into plural microphones and a program therefor, a sound signal processor for processing input sound signals, and a voice recognition device for detecting a speech sound and processing voice recognition of the speech sound.

2. Description of the Related Art

In various forms of communication used by humans, voice is the most basic and preferred form of communication, with its information transmission speed higher than any other information transmission method. Thus, until recently, the voice has served as the basis of human communication since ancient times.

There are proposed voice recognition techniques for recognizing the voice. Voice recognition includes extracting the most basic information on the semantic contents, or phonological information, from the information contained in the voice with a computer or other data processing device, and determining the extracted contents. In recent years, attempts have been made to apply such voice recognition techniques as a man-machine interface in various fields, with the drastic development of computer processor technology and the construction of advanced information networks, typically the Internet.

The recognition performance of current voice recognition systems has improved greatly with the utilization of probabilistic and statistical schemes. In the case of voice in ideal environments and voice collected at a short distance with a close-talking microphone, a significantly high recognition rate is obtained.

However, when it comes to voice recognition in actual environments, the recognition rate is inferior because of the mismatch between learning data and observed data in their environments, contents of speech, and other factors. In addition, users suffer great burden and discomfort from a close-talking microphone headset as a sound reception system worn by the user. This significantly hinders the practical application of voice recognition systems.

Further, many studies have been conducted on voice recognition methods using plural remote microphones for picking up remote voices. However, such studies have shown that it is difficult to recognize the remote voices because of their lower S/N ratio, influences of background noise and room reverberation, and other factors. A typical method uses a microphone array. This method can perform three types of spatial signal processing, namely sound source position detection processing, target sound emphasis processing, and noise suppression processing. Remote voice recognition is being extensively researched using methods such as the method described above.

However, this method requires plural microphones to be fixed at regular intervals for accurate identification processing of the direction of the speaker, and thus, downsizing and mobilization of such a method is difficult. Therefore, there is a problem that this method is difficult to apply to voice input in various environments and under various circumstances and thus has limited uses.

As a mobile sound reception system enabling anytime/anywhere sound input, mountable microphones that can be attached to clothes, glasses or other articles can be provided, which (1) are compact and lightweight for easy mounting/removing, (2) ensure short-distance sound pickup similar to close-talking microphones, and (3) reduce the burden and discomfort when mounted to the user as compared to close-talking microphone headsets.

### SUMMARY OF THE INVENTION

To overcome the problems described above, preferred embodiments of the present invention provide a method for detecting a target sound, a method for detecting a delay time in signal input, a sound signal processor, a voice recognition device, and programs therefor, which enable the construction of a sound reception system including plural mountable microphones and which is highly resistant to environmental fluctuations.

A method for detecting a target sound according to a preferred embodiment of the present invention includes inputting sounds output from a sound source into plural microphones, detecting a phase of a cross-spectrum between sound signals input into the plural microphones, detecting an inclination of the phase of the cross-spectrum with respect to a frequency due to respective distances from the sound source to the plural microphones, and, based on the inclination, determining whether the sound input to the plural microphones includes the target sound.

The method for detecting a target sound preferably includes dividing the frequency into a plurality of bands, detecting the inclination of the phase for each of the plurality of bands, and, based on the detected inclinations of the phase of each of the plurality of bands, determining whether the sound input into the plural microphones includes the target sound.

The method for detecting a target sound also preferably includes detecting the target sound when the detected inclinations of the plurality of bands are concentrated near a specific inclination.

The method for detecting a target sound preferably includes dividing the sound signals that are input into the plural microphones into predetermined time sections, and detecting the phase of the cross-spectrum between the sound signals in each time section.

A method for detecting a delay time in signal input according to another preferred embodiment of the present invention includes inputting sounds that are output from a sound source into plural microphones, detecting a phase of a cross-spectrum between sound signals that are input into the plural microphones, detecting an inclination of the phase of the cross-spectrum with respect to a frequency due to respective distances from the sound source to the plural microphones, and, based on the inclination, determining the delay time in signal input of the sounds input into the plural microphones from the sound source.

The method for detecting a delay time in signal input preferably includes dividing the frequency into a plurality of bands, detecting the inclination of the phase of each of the plurality of bands, and, based on the detected inclinations of the phase of each of the plurality of divided bands, determining the delay time.

The method for detecting a delay time in signal input preferably includes determining the delay time when the inclinations of each of the plurality of bands are concentrated near a specific inclination.

The method for detecting a delay time in signal input preferably includes dividing the sound signals input into the plural microphones into predetermined time sections, and detecting the phase of the cross-spectrum between the sound signals in each time section.

A sound signal processor according to another preferred embodiment of the present invention includes a cross-spectrum phase detector for detecting a phase of a cross-spectrum between sound signals input into plural microphones, an inclination detector for detecting an inclination of the phase of the cross-spectrum detected by the cross-spectrum phase detector with respect to a frequency, and a target sound detector for detecting whether the sound input into the plural microphones includes a target sound based on the inclination with respect to the frequency detected by the inclination detector.

The inclination detector of the sound signal processor preferably divides the frequency of the phase of the cross-spectrum into a plurality of bands and detects inclinations of each of the plurality of bands, and the target sound detector detects whether the sound input into the plural microphones includes the target sound based on the inclination of each of the plurality of bands detected by the inclination detector.

A sound signal processor for processing a sound output from a sound source and input into plural microphones according to another preferred embodiment of the present invention includes a cross-spectrum phase detector for detecting a phase of a cross-spectrum between sound signals input into the plural microphones, an inclination detector for detecting an inclination of the phase of the cross-spectrum detected by the cross-spectrum phase detector with respect to a frequency, a delay time detector for detecting a delay time in the sound signals input into the plural microphones based on the inclination with respect to the frequency detected by the inclination detector.

The present preferred embodiment also preferably includes a sound signal synthesizer for synthesizing the sound signals that are input into the plural microphones based on the delay time detected by the delay time detector.

The inclination detector of the sound signal processor preferably divides the phase of the cross-spectrum into a plurality of bands and detects inclinations of each of the plurality of bands, and the delay time detector detects the delay time based on the inclinations of each of the plurality of bands detected by the inclination detector.

A sound signal processor for processing a detection target sound output from a detection target sound source and input into plural microphones according to another preferred embodiment of the present invention includes a cross-spectrum phase detector for detecting a phase of a cross-spectrum between sound signals that are input into the plural microphones, an inclination detector for detecting an inclination of the phase of the cross-spectrum detected by the cross-spectrum phase detector with respect to a frequency, a delay time detector for detecting a delay time in the sound signals input into the plural microphones based on the inclination with respect to the frequency detected by the inclination detector, a sound signal synthesizer for synthesizing the sound signals that are input into the plural microphones based on the delay time detected by the delay time detector, and a target sound detector for determining whether the sound in the synthesized sound signals synthesized by the sound signal synthesizer includes a target sound based on the inclination with respect to the frequency detected by the inclination detector.

The inclination detector of the sound signal processor preferably divides the phase of the cross-spectrum into a plurality of bands and detects inclinations of each of the plurality of bands, the delay time detector preferably detects the delay time based on the inclinations of each of the plurality of bands detected by the inclination detector, and the target sound detector preferably detects the target sound based on the inclinations of each of the plurality of bands detected by the inclination detector.

A voice recognition device for processing a speech sound output from a speech sound source and input into plural microphones according to another preferred embodiment of the present invention includes a cross-spectrum phase detector for detecting a phase of a cross-spectrum between sound signals that are input into the plural microphones, an inclination detector for detecting an inclination of the phase of the cross-spectrum detected by the cross-spectrum phase detector with respect to a frequency, a speech sound detector for detecting whether the sound signals input into the plural microphones includes the speech sound based on the inclination with respect to the frequency detected by the inclination detector, and a voice recognition processor for performing voice recognition processing of the speech sound detected by the speech sound detector.

The inclination detector of the voice recognition device preferably divides the frequency of the phase of the cross-spectrum into a plurality of bands and detects inclinations of each of the plurality of bands, and the speech sound detector preferably detects the speech sound based on the inclinations of each of the plurality of bands detected by the inclination detector.

A voice recognition device for processing a speech sound output from a speech sound source and input into plural microphones according to another preferred embodiment of the present invention includes a cross-spectrum phase detector for detecting a phase of a cross-spectrum between sound signals input into the plural microphones, an inclination detector for detecting an inclination of the phase of the cross-spectrum detected by the cross-spectrum phase detector with respect to a frequency, a delay time detector for detecting a delay time in the sound signals input into the plural microphones based on the inclination with respect to the frequency detected by the inclination detector, a sound signal synthesizer for synthesizing the sound signals input into the plural microphones based on the delay time detected by the delay time detector, a speech sound detector for detecting whether the synthesized sound signals synthesized by the sound signal synthesizer include the speech sound based on the inclination with respect to the frequency detected by the inclination detector, and a voice recognition processor for performing voice recognition processing of the speech sound detected by the speech sound detector.

The inclination detector of the voice recognition device preferably divides the phase of the cross-spectrum into a plurality of bands and detects inclinations of each of the plurality of bands, the delay time detector detects the delay time based on the inclinations of each of the plurality of bands detected by the inclination detector, and the speech sound detector detects the speech sound based on the inclinations of each of the plurality of bands detected by the inclination detector.

A program according to another preferred embodiment of the present invention enables a computer to perform a process of detecting a target sound, the process includes the steps of inputting sounds output from a sound source into plural microphones, detecting a phase of a cross-spectrum between sound signals input into the plural microphones, detecting an inclination of the phase of the cross-spectrum with respect to a frequency due to respective distances from the sound source to the plural microphones, and, based on the inclination, determining whether the sound input into the plural microphones includes the target sound.

A program according to another preferred embodiment of the present invention enables a computer to perform a process of detecting a delay time in sound input, the process including the steps of inputting sounds output from a sound source into plural microphones, detecting a phase of a cross-spectrum between sound signals input into the plural microphones, detecting an inclination of the phase of the cross-spectrum with respect to the frequency due to respective distances from the sound source to the plural microphones, and, based on the inclination, determining a delay time in signals input into the plural microphones.

Examining the phase of a cross-spectrum of plural sound signals picked up by plural microphones, the inclination of the phase with respect to the frequency is constant, depending on the difference between the respective distances from the sound source to the microphones. The difference between the respective distances from the sound source to the microphones appears as a delay time in sound reception between the plural microphones. When the S/N ratio of the sound picked up by the plural microphones is increased, the tendency of a constant inclination is increased. Various preferred embodiments of the present invention preferably utilize this relationship.

That is, in various preferred embodiments of the present invention, the phase of a cross-spectrum between sound signals input into plural microphones is detected, the inclination of the phase of the cross-spectrum with respect to the frequency due to the respective distances from the sound source to the plural microphones is detected, and, based on the detected inclination, it is determined whether a target sound or speech sound has been received by the plural microphones is detected. The target sound may include ambient sound, in addition to speech sound produced by humans.

Various preferred embodiments of the present invention operate based on the principle that, examining the phase of a cross-spectrum of plural sound signals input into plural microphones, the inclination of the phase with respect to the frequency is constant, depending on the difference between the distances from the sound source to the microphones, and that the tendency of such a constant inclination is increased when the S/N of the sound picked up by the plural microphones is increased.

In addition, in various preferred embodiments of the present invention, the phase of a cross-spectrum between sound signals input into plural microphones is detected, the inclination of the phase of the cross-spectrum with respect to the frequency due to the respective distances from the sound source to the plural microphones is detected, and, based on the inclination, a delay time in reception of sound or sound signals between the plural microphones is detected.

Various preferred embodiments of the present invention operate based on the principle that, examining the phase of a cross-spectrum of plural sound signals input into plural microphones, the inclination of the phase with respect to the frequency is constant, depending on the difference between the respective distances from the sound source to the microphones, and that the difference between the respective distances from the sound source to the microphones appears as a delay time in sound reception between the plural microphones.

In various preferred embodiments of the present invention, the frequency of the phase of a cross-spectrum is divided into a plurality of bands, and the processing is performed based on the inclinations of each of the plurality of divided bands. This provides detection of the inclinations with high accuracy.

Other features, elements, steps, characteristics and advantages of the present invention will become more apparent from the following detailed description of preferred embodiments with reference to the attached drawings.

### BRIEF DESCRIPTION OF THE DRAWINGS

FIG. 1 is a block diagram showing the entire construction of a system including a sound signal processor of a preferred embodiment of the present invention.

FIG. 2 is a block diagram showing the construction of a sound signal processor of a first preferred embodiment of the present invention.

FIG. 3 is a property diagram showing the phase of a cross-spectrum in respective environments.

FIG. 4 is a property diagram showing the phase of a cross-spectrum, in which (A) is a property diagram showing the phase of a cross-spectrum of a voiced frame and (B) is a property diagram showing the phase of a cross-spectrum of a voiceless frame.

FIG. 5 is a property diagram showing a histogram obtained based on the phase of a cross-spectrum, in which (A) is a property diagram showing a histogram of a voiced frame and (B) is a property diagram showing a histogram of a voiceless frame.

FIG. 6 is a block diagram showing the construction of a histogram calculating section of the sound signal processor.

FIG. 7 is a property diagram used for describing the effects of the sound signal processor of the first preferred embodiment of the present invention.

FIG. 8 is a block diagram showing the construction of a sound signal processor of a second preferred embodiment of the present invention.

FIG. 9 is a diagram used for describing the Overlap-add method for generating synthesized signals.

FIG. 10 is a property diagram used for describing the effects of the sound signal processor of the second preferred embodiment of the present invention.

FIG. 11 is a block diagram showing the construction of a sound signal processor of a third preferred embodiment of the present invention.

FIG. 12 is a block diagram showing another construction of a voiced/voiceless determining section of the sound signal processor.

### DETAILED DESCRIPTION OF PREFERRED EMBODIMENTS

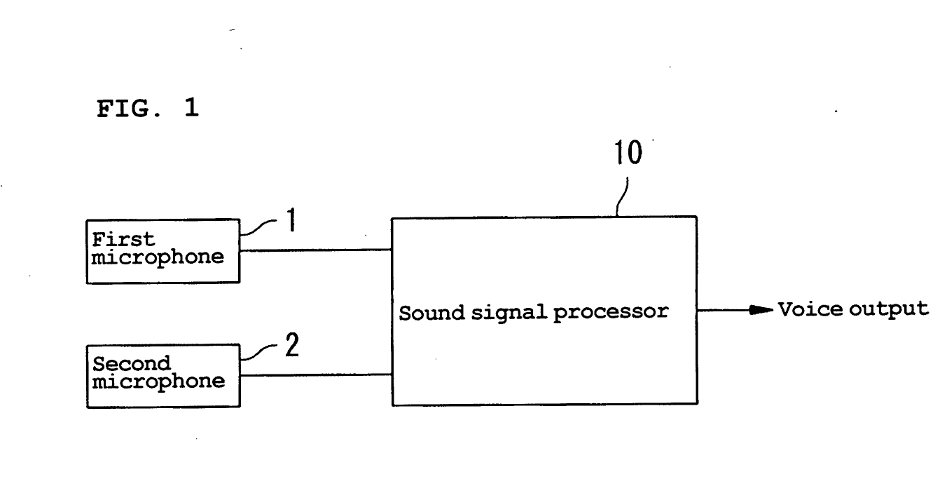

A preferred embodiment of the present invention is described below with reference to the drawings. As shown in FIG. 1, this preferred embodiment is a sound signal processor 10 for processing sound signals picked up by two microphones 1 and 2. The first and second microphones 1 and 2 are preferably of a mountable type that can be mounted to a sound source (user) with a comparatively high degree of freedom in mounting locations.

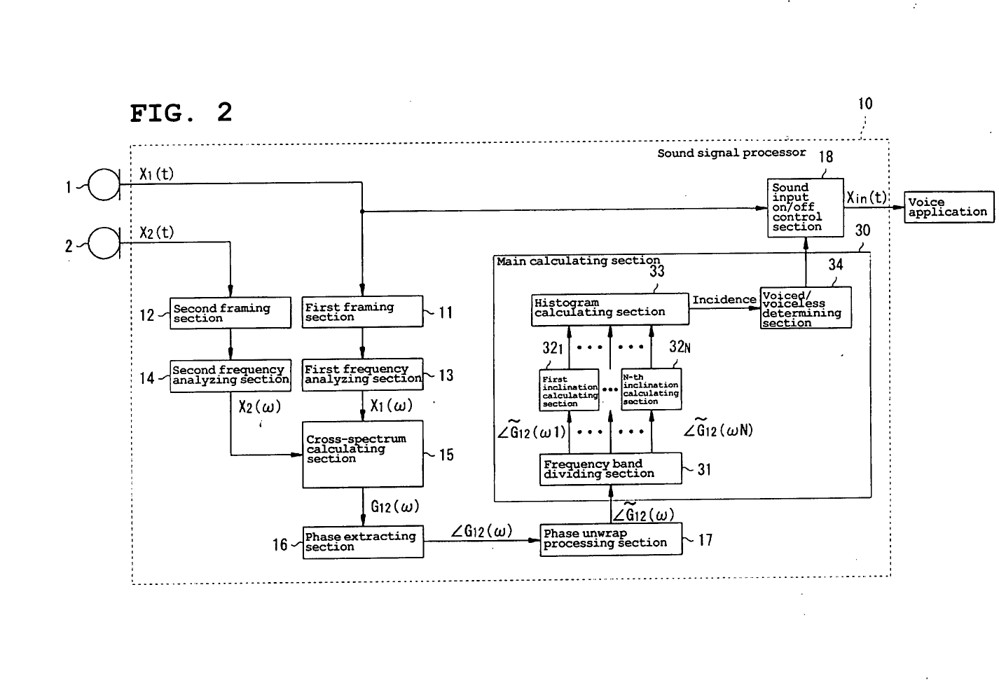

FIG. 2 shows the construction of the sound signal processor 10 of a first preferred embodiment. As shown in FIG. 2, the sound signal processor 10 includes first and second framing sections 11 and 12, first and second frequency analyzing sections 13 and 14, a cross-spectrum calculating section 15, a phase extraction processing section 16, a phase unwrap processing section 17, a main calculating section 30, and a sound input on/off control section 18. The main calculating section 30 includes a frequency band dividing section 31, first through N-th inclination calculating section 32₁ through 32_{N}, a histogram calculating section 33, and a voiced/voiceless determining section 34. The processing operation of each section is described below.

Two-channel sound signals input from the first and second microphones 1 and 2 are input into the first and second framing sections 11 and 12, respectively. The sound signals input from the first microphone 1 are also input into the sound input on/off control section 18.

The first and second framing sections 11 and 12, the first and second frequency analyzing sections 13 and 14, and the cross-spectrum calculating section 15 calculate a cross-spectrum of the two-channel sound signals input from the first and second microphones 1 and 2.

For example, when sound signals picked up by plural microphones, such as the first and second microphones 1 and 2, are observed in a time series, there is a phase difference between the received sound signals. This results from the difference between the arrival times of the sound signals from the sound source to the microphones 1 and 2 due to the difference between the distances from the sound source to the microphones 1 and 2.

Here, a case is examined in which the delay time between the sound signals picked up by the first and second microphones 1 and 2 is measured, the phases of those signals are synchronized based on the measured delay time, and then the sound signals picked up by the first and second microphones 1 and 2 are added to obtain synchronized added sound. Such a technique for obtaining synchronized added sound as described above is disclosed in, for example, “Acoustic Event Localization Using A Crosspower-Spectrum Phase Based Technique,” by M. Omologo, P. Svaizer et al., Proc. ICASSP94, pp. 274-276 (1994).

The sound signals picked up by the first and second microphones 1 and 2 are represented as x₁(t) and x₂(t), respectively, and frequency functions obtained by Fourier transformations of these sound signals x₁(t) and x₂(t) are represented as X₁(ω) and X₂(ω), respectively. The sound signal x₂(t) is assumed to be a time-shifted waveform of the sound signal x₁(t) as represented by the following equation (1):

x₂(t)=x₁(t−t₀) (1)

On this assumption, the relationship between the frequency functions X₁(ω) and X₂(ω) can be represented by the following equation (2):

X₂(ω)=e^{-j}ω^{t0}X₁(ω) (2)

Then, from the frequency functions X₁(ω) and X₂(ω), a cross-spectrum G₁₂(ω) can be obtained as represented by the following equation (3):

G₁₂(ω)=X₁(ω)X₂*(ω)=X₁(ω)e^{j}ω^{t0}X₁*(ω)=|X₁|²e^{j}ω^{t0} (3)

The exponent term of the cross-spectrum G₁₂(ω) corresponds to the time delay between the channels in the spectrum region. Thus, X₂(ω)e^{j}ω^{t0}, obtained by multiplying the frequency function X₂ by the delay term e^{j}ω^{t0}, is synchronized with the frequency function X₁, whereby the inverse Fourier transform of X₁(ω)+X₂ (ω) e^{j}ω^{t0} can be used as channel-synchronized-added sound.

The cross-spectrum G₁₂ (ω) such as described above is obtained by the cross-spectrum calculating section 15.

To this end, the first framing section 11 performs framing of the sound signals input from the first microphone 1 (or divides them into frames), in preparation for the first frequency analyzing section 13, and outputs the results to the first frequency analyzing section 13. Also, the second framing section 12 performs framing of the sound signals inputted from the second microphone 2 (or divides them into frames), in preparation for the second frequency analyzing section 14, and outputs the results to the second frequency analyzing section 14. The first and second framing sections 11 and 12 progressively divide the input sound signals into frames, with each frame including a predetermined number of samples.

For example, when no voice (speech) is input into the microphones 1 and 2, voiceless frames carrying no voice are generated, and when voice is input into the microphones 1 and 2, voiced frames carrying voice (speech) are generated.

The first frequency analyzing section 13 performs Fourier transformations of the sound signals from the first framing section 11 to calculate the frequency function X₁(ω), and outputs it to the cross-spectrum calculating section 15 as the next step. The second frequency analyzing section 14 performs Fourier transformations of the sound signals from the second framing section 12 to calculate the frequency function X₂(ω), and outputs it to the cross-spectrum calculating section 15. The first and second frequency analyzing sections 13 and 14 perform a Fourier transformation for each frame of the sound signals.

The cross-spectrum calculating section 15 calculates the cross-spectrum G₁₂(ω) based on the frequency functions X₁(ω) and X₂(ω) obtained from the first and second frequency analyzing sections 13 and 14, using the equation (3).

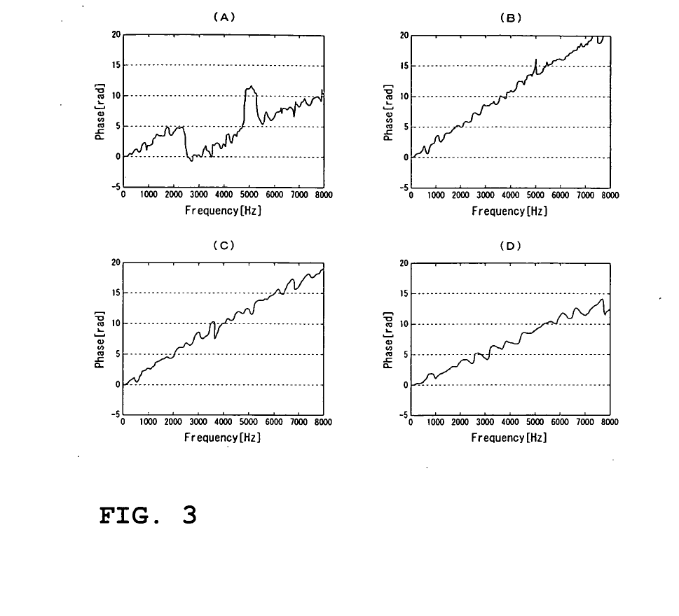

FIG. 3 shows examples of the phase of a cross-spectrum of sound signals for one frame. In FIG. 3, (A) shows the phase of a cross-spectrum obtained from sound produced in a car, (B) shows the phase of a cross-spectrum obtained from sound produced in an office space, (C) shows the phase of a cross-spectrum obtained from sound produced in a soundproof room, and (D) shows the phase of a cross-spectrum obtained from sound produced on a sidewalk (outdoor). As shown in FIG. 3, the phase of the cross-spectrum exhibits a generally constant inclination with respect to the frequency within a frame, depending on the difference between the distances from the sound source to the first and second microphones 1 and 2. In other words, the phase component of the cross-spectrum has a constant inclination depending on the difference between the distances from the sound source to the first and second microphones 1 and 2.

When the S/N ratio of the sound signals picked up by the first and second microphones 1 and 2 is increased, the tendency of a constant inclination is increased. Since the first and second microphones 1 and 2 are preferably of a mountable type, the S/N ratio of the sound signals picked up by the first and second microphones 1 and 2 is high. Thus, each of the phases of the cross-spectra exhibits a constant inclination.

The cross-spectrum calculating section 15 outputs a cross-spectrum G₁₂(ω) with such properties to the phase extracting section 16.

The phase extracting section 16 extracts (detects) the phase of the cross-spectrum G₁₂(ω) obtained from the cross-spectrum calculating section 15, and outputs the results of the extraction to the phase unwrap processing section 17.

The phase unwrap processing section 17 unwraps the cross-spectrum G₁₂(ω) based on the results of the phase extraction in the phase extracting section 16, and outputs the results of the unwrapping to the frequency band dividing section 31 of the main calculating section 30.

The frequency band dividing section 31 outputs segments obtained by dividing the phase according to the band to the first through N-th inclination calculating sections 32₁ through 32_{N}, respectively.

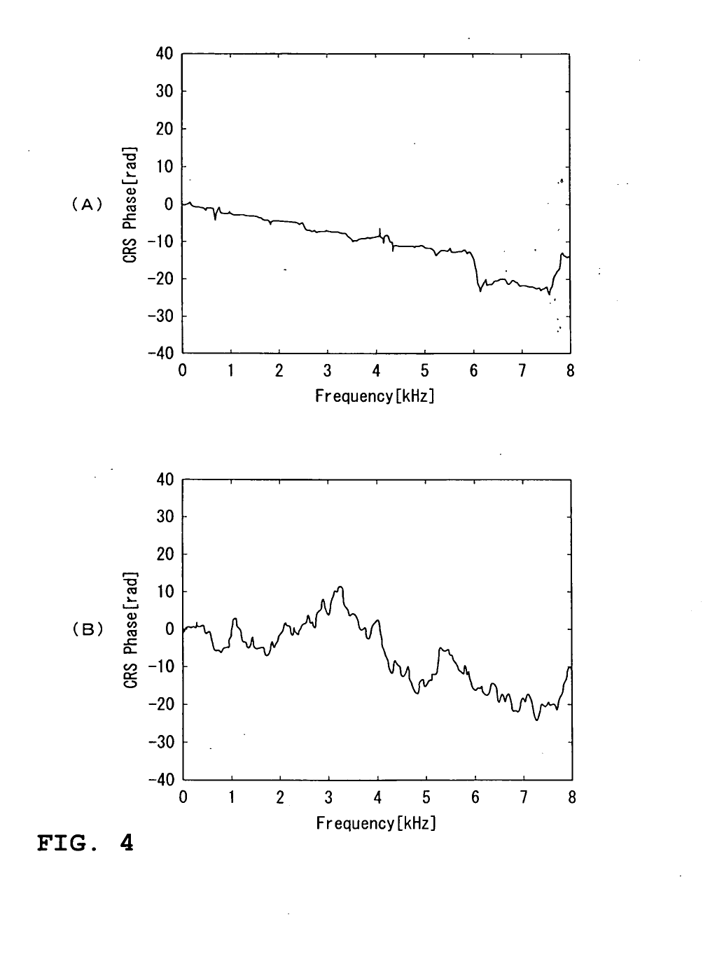

Note that there is a significant difference in the phase components of a cross-spectrum between voiceless frames carrying no voice and voiced frames carrying voice. That is, the phase of a cross-spectrum has a generally constant inclination with respect to the frequency in voiced frames, and does not in voiceless frames. A description is made with reference to FIG. 4.

FIG. 4 shows examples of the phase of a cross-spectrum (CRS) In FIG. 4, (A) shows the phase of a cross-spectrum of a voiced frame, and (B) shows the phase of a cross-spectrum of a voiceless frame.

As seen from this comparison of FIG. 4(A) and FIG. 4(B), the phase of a cross-spectrum in voiceless frames has no specific trend with respect to the frequency. In other words, the phase of a cross-spectrum does not have a constant inclination with respect to the frequency. This is because the noise has a random phase.

On the other hand, the phase of a cross-spectrum in voiced frames has a constant inclination with respect to the frequency. This inclination depends on the difference between the distances from the sound source to the microphones 1 and 2.

As described above, there is a significant difference in the phase components of across-spectrum between voiceless frames carrying no voice and voiced frames carrying voice.

In view of the above, the frequency band dividing section 31 divides the phase components into small frequency segments (or divides them according to the band) and the first through N-th inclination calculating sections 32₁ through 32_{N} calculate the inclinations of each segment by applying the least squares method, so as to follow the trend correctly even when the phase is rotated. The first through N-th inclination calculating sections 32₁ to 32_{N} respectively output the calculated inclination to the histogram calculating section 33.

The method for obtaining the inclinations of each segment by applying the least squares method is a known technique disclosed, for example, in “Introduction to Signal Processing and Image Processing,” by Nobukatsu Takai, Kougakusha (2000).

The histogram calculating section 33 obtains a histogram based on the inclinations calculated by the first through N-th inclination calculating sections 32₁ to 32_{N}.

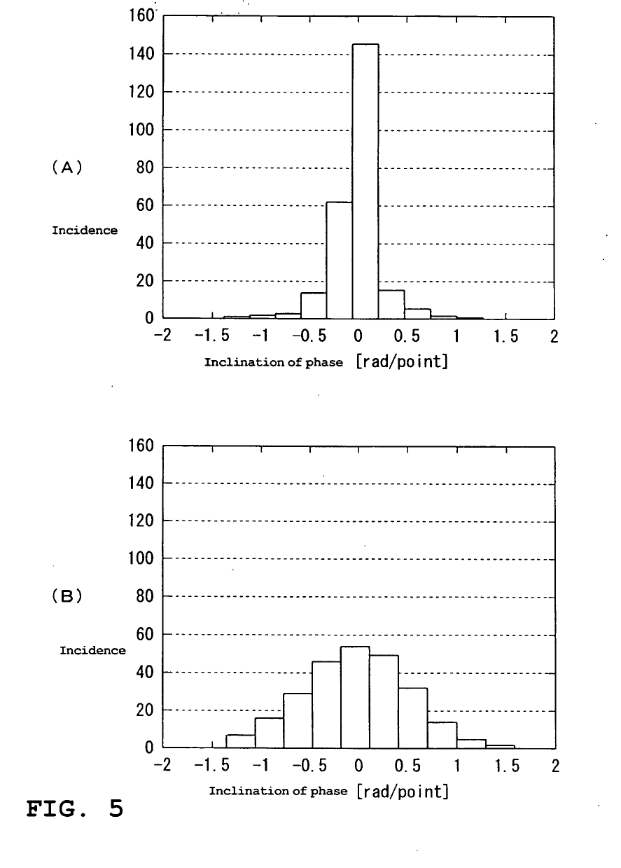

FIG. 5 shows histograms obtained by the histogram calculating section 33, with each histogram showing inclinations by the segment. In other words, FIG. 5 shows the distribution of inclinations of the phase, with the vertical axis representing the ratio, or incidence, of the segments of each inclination to all the segments. In FIG. 5, (A) shows a histogram of a voiced frame, and (B) shows a histogram of a voiceless frame.

As seen from this comparison of (A) and (B) of FIG. 5, in voiced frames, the histogram obviously has a peak value. That is, the inclinations are localized within a significantly narrow range, with a high incidence of inclinations of a specific range. In other words, there is a strong tendency of the inclinations of each band to be concentrated on a specific inclination. On the other hand, in voiceless frames, the histogram has a smooth shape, with the inclinations distributed over a wider range.

The histogram calculating section 33 outputs the incidences obtained by creating these histograms to the voiced/voiceless determining section 34. A specific example of the processing performed by the histogram calculating section 33 will be described below.

The voiced/voiceless determining section 34 determines voiced and voiceless sections based on the incidences obtained from the histogram calculating section 33. For example, a section is determined to be a voiced section when the occurring incidence of inclinations included within a predetermined range around the mean value of the incidences is not less than a predetermined threshold, whereas a section is determined to be a voiceless section when that occurring incidence is less than the predetermined threshold.

Here, a frame is determined to be a voiced frame or a voiceless frame, since the processing at the previous step was performed frame by frame. The voiced/voiceless determining section 34 outputs the determination results to the sound input on/off control section 18.

The sound input on/off control section 18 receives the sound signals from the first microphone 1, and switches on and off these sound signals to be output to the next step based on the determination results of the voiced/voiceless determining section 34. Specifically, when the voiced/voiceless determining section 34 determines sound signals to be a voiced section, the sound input on/off control section 18 switches on so as to output the sound signals to the next step. When the voiced/voiceless determining section 34 determine sound signals to be a voiceless section, the sound input on/off control section 18 switches off so as not to output the sound signals to the next step.

Here, the sound input on/off control section 18 switches the portion of the sound signals on and off as a unit from the first microphone 1 corresponding to the frame on which the determination was made, since the processing at the previous step was performed frame by frame.

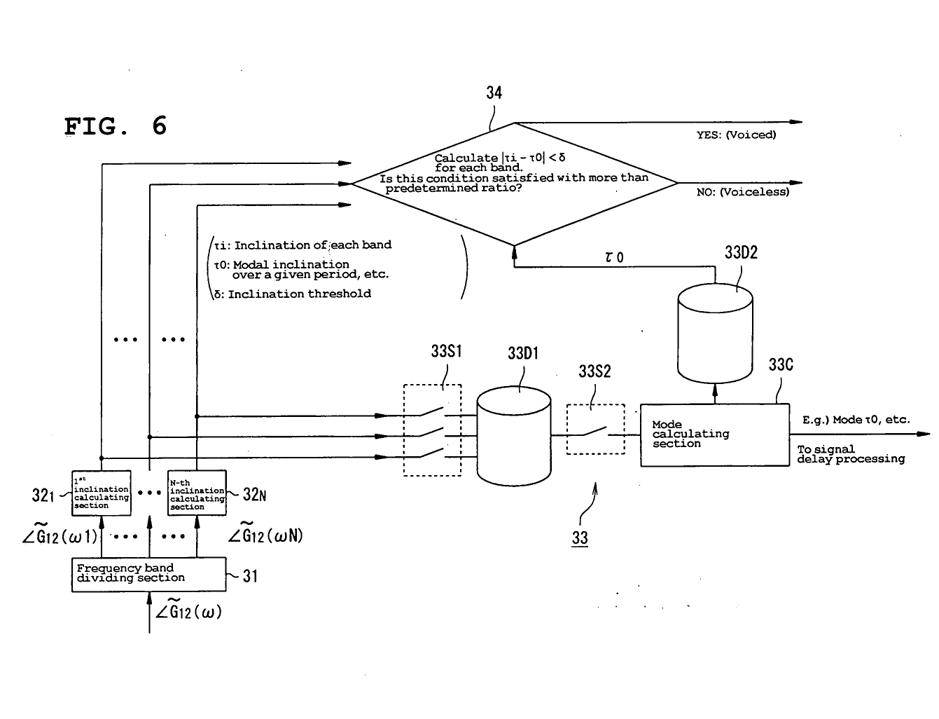

A specific example of the processing performed by the histogram calculating section 33 is described. FIG. 6 shows the construction of the histogram calculating section 33 for performing the processing.

The histogram calculating section 33 preferably includes a first switch 33S1, a second switch 33S2, and a mode calculating section 33C, for calculating an inclination of a high incidence (modal inclination) from the inclinations calculated by the first through N-th inclination calculating sections 32₁ through 32_{N}. The histogram calculating section 33 switches on (closed) the first switch 33S1 for a given period, to create data (or a database) 33D1 of inclinations for the given period calculated by the first through N-th inclination calculating sections 32₁ through 32_{N}. Note that the second switch 33S2 is kept off (opened) at this time. When the data 33D1 are created, the second switch 33S2 is switched on (closed) so as to output the data 33D1 to the mode calculating section 33C.

The mode calculating section 33C creates a histogram representing the inclinations as shown in FIG. 5 from the data 33D1, and calculates the inclination of the highest incidence (hereinafter referred to as modal inclination) τ0 in the histogram. Instead of calculating the inclination of the highest incidence, it is also possible to calculate the inclination of the mean value τ0 or an inclination τ0 as a combination of the inclination of the highest incidence and the mean value of the inclinations. Thus, when there is a strong tendency of the inclinations of each band to be concentrated on a specific inclination, the exact value, or an approximate value, of the specific inclination is obtained. In this preferred embodiment, the mode calculating section 33C calculates the modal inclination τ0.

Then, the mode calculating section 33C outputs the calculated modal inclination τ0 to the voiced/voiceless determining section 34. The modal inclination τ0 is output to the voiced/voiceless determining section 34 as data 33D2.

The foregoing is one specific example of the processing performed by the histogram calculating section 33 but is in no way limiting thereof.

The voiced/voiceless determining section 34 determines voiced and voiceless sections based on the modal inclination τ0 from the histogram calculating section 33.

In the preceding description, the voiced/voiceless determining section 34 determines voiced and voiceless sections based on the incidences obtained from the histogram calculating section 33. The voiced/voiceless determining section 34 determines voiced and voiceless sections based on the modal inclination τ0 obtained from the histogram calculating section 33 and the inclinations (of each band) τi calculated by the first through N-th inclination calculating sections 32₁ through 32_{N}. Therefore, the voiced/voiceless determining section 34 is adapted to receive the inclinations calculated by the first through N-th inclination calculating sections 32₁ through 32_{N}.

The voiced/voiceless determining section 34 compares the inclinations Ti calculated by the first through N-th inclination calculating sections 32₁ through 32_{N} and the modal inclination TO, using the following inequality (4):

|τi−τ0 |<δ (4)

wherein δ represents a threshold used for the determination (inclination threshold).

The voiced/voiceless determining section 34 determines a section to be a voiced section when the condition of the inequality (4) is satisfied with more than a predetermined ratio (YES), and determines a section to be a voiceless section when the predetermined ratio is not satisfied (NO). Then, the voiced/voiceless determining section 34 outputs the determination results to the sound input on/off control section 18.

The sound signal processor 10 constructed as described above functions as follows.

First, the first and second framing sections 11 and 12, the first and second frequency analyzing sections 13 and 14, and the cross-spectrum calculating section 15 calculate a cross-spectrum G₁₂(ω) of two-channel sound signals inputted from the first and second microphones 1 and 2.

Then, the phase extracting section 16, the phase unwrap processing section 17, and the frequency band dividing section 31 divide the phase of the calculated cross-spectrum G₁₂(ω) according to the band (divided into segments), and the first through N-th inclination calculating sections 32₁ through 32_{N} calculate the inclinations of the phase of each band (each segment).

Then, the histogram calculating section 33 generates a histogram based on the inclinations of each band (each segment) calculated respectively by the first through N-th inclination calculating sections 32₁ through 32_{N}, and the voiced/voiceless determining section 34 determines voiced and voiceless sections based on the incidences and the modal inclination τ0 obtained from the histogram. Based on the determination results, the sound input on/off control section 18 switches on and off the sound signals from the first and second microphones 1 and 2 to be output to the next step. Specifically, when the voiced/voiceless determining section 34 determines sound signals to be a voiced section, the sound input on/off control section 18 switches on to output the sound signals to the next step. When the voiced/voiceless determining section 34 determines sound signals to be a voiceless section, the sound input on/off control section 18 switches off so as not to output the sound signals to the next step.

In this manner, the sound signal processor 10 detects speech sections (voiced sections) contained in the sound picked up by the first and second microphones 1 and 2.

Implementation of such a sound signal processor between the first and second microphones 1 and 2 and a voice application, for example, enables the voice application to securely perform processing related to speech sections. The voice application includes a voice recognition system, a broadcasting system, a cellular phone, and a transceiver. For example, when the voice application is a voice recognition system, the voice recognition system performs voice recognition based on the sound signals contained in speech sections that are output by the sound signal processor 10.

The effects are described below.

As described previously, the phase of a cross-spectrum between the sound signals input into the first and second microphones 1 and 2 is detected, and speech sections contained in the sound signals picked up by the plural microphones are detected based on the inclination of the detected phase of the cross-spectrum with respect to the frequency. In other words, speech sections contained in the sound signals picked up by the plural microphones are detected utilizing the significant difference in the phase components of a cross-spectrum generated from sound signals containing no voice (speech) and sound signals containing voice (speech).

Specifically, the phase of the cross-spectrum is divided according to the band (divided into segments), a histogram is generated based on the inclinations of the phase of each band (each segment), an incidence (specifically mode) is obtained from the histogram, and speech sections are detected based on the incidence.

This enables accurate detection of speech sections. Further, utilizing such sound signals contained in the speech sections detected by the sound signal processor 10 enables voice recognition with a high recognition rate/low misrecognition rate in a voice recognition system, hands-free, half-duplex operation with high reliability in a cellular phone and a transceiver, and reduction of the power consumption of the communication system in a broadcasting system.

Even in the case of varying environmental conditions, such as a change in the mounting locations of the microphones, and movement of the sound source, such as movement or a change in posture of the speaker, outstanding voice input is achieved.

As described previously, the inclination of the phase of a cross-spectrum with respect to the frequency changes depends on the difference between the distances from the sound source to the first and second microphones 1 and 2. Thus, when the mounting locations of the first and second microphones 1 and 2 relative to the sound source are changed, for example, the inclination of the phase of the cross-spectrum with respect to the frequency is also changed in response to the changes in the locations. Meanwhile, as described previously, the phase of the cross-spectrum is divided according to the band (divided into segments), a histogram is generated based on the inclinations of the phase of each band (each segment), an incidence (specifically mode) is obtained from the histogram, and speech sections are detected based on the incidence. In other words, speech sections are detected, irrespective of the magnitude of the inclination of the phase of the cross-spectrum, or the distances from the sound source to the microphones 1 and 2. Therefore, even when the mounting locations of the first and second microphones 1 and 2 relative to the sound source are changed, the detection results of speech sections are not affected.

As a result, even when environmental changes occur, such as in the mounting locations of the microphones, and movement of the sound source, such as movement or a change in posture of the speaker, outstanding voice input is achieved. In other words, outstanding voice input is achieved while maintaining a high degree of freedom in the locations of the microphones.

As described above, the aforementioned various effects are obtained even when using mountable microphones, which are compact and lightweight for easy mounting/removing, ensure short-distance sound pickup similar to close-talking microphones, and reduce the burden and discomfort when mounted to the user as compared to close-talking microphone headsets.

A detection of a speech section containing voice was performed using a system to which the present preferred embodiment of the present invention was applied. A total of forty sentences with a voiceless section of about one second intervening between sentences was used as sample sound. Experiments were performed in the following environments: in a soundproof room, in a car, in an office space, and on a sidewalk. For evaluation, a frame was determined to be an error frame when (1) a voiceless frame was incorrectly determined to be a voiced frame, or (2) judging from its leading end and trailing end, a speech section was determined to be a non-speech section. As a comparison object (conventional example), a method was used utilizing a Fisher's linear discriminant function using the average number of zero-crossings and the logarithmic power as variables.

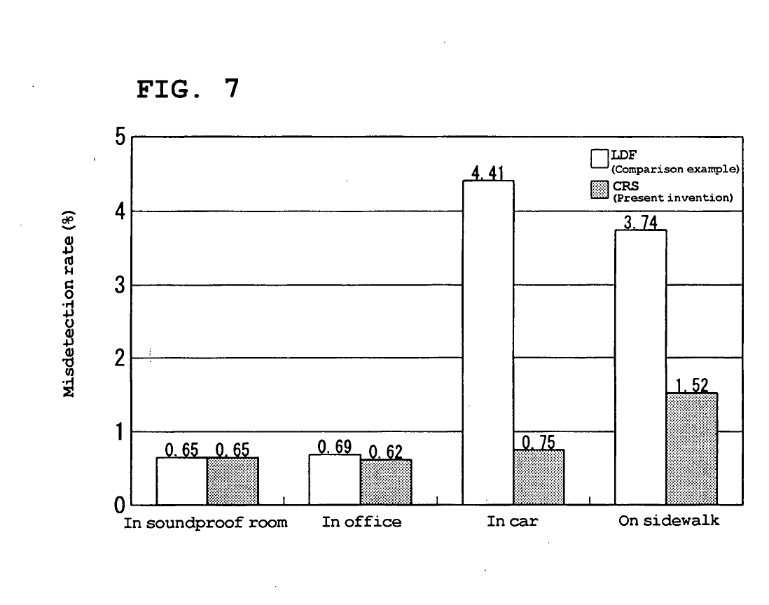

FIG. 7 shows the results. FIG. 7 shows the percentage of the ratio of error frames to the total frames (speech section misdetection rate). In FIG. 7, the values designated as LDF are those obtained by the method utilizing the linear discriminant function, while the values designated as CRS are those obtained by the method utilizing the cross-spectrum (the present invention).

As shown in FIG. 7, in a soundproof room and in an office space, no substantial difference was observed in resulting speech section misdetection rate between the method utilizing the average number of zero-crossings and the logarithmic power and the method of preferred embodiments of the present invention. However, in a car and on a sidewalk, the method according to preferred embodiments of the present invention produced greatly improved results in the speech section misdetection rate. Thus, the present invention functions effectively particularly in noisy environments.

A second preferred embodiment is described hereinafter.

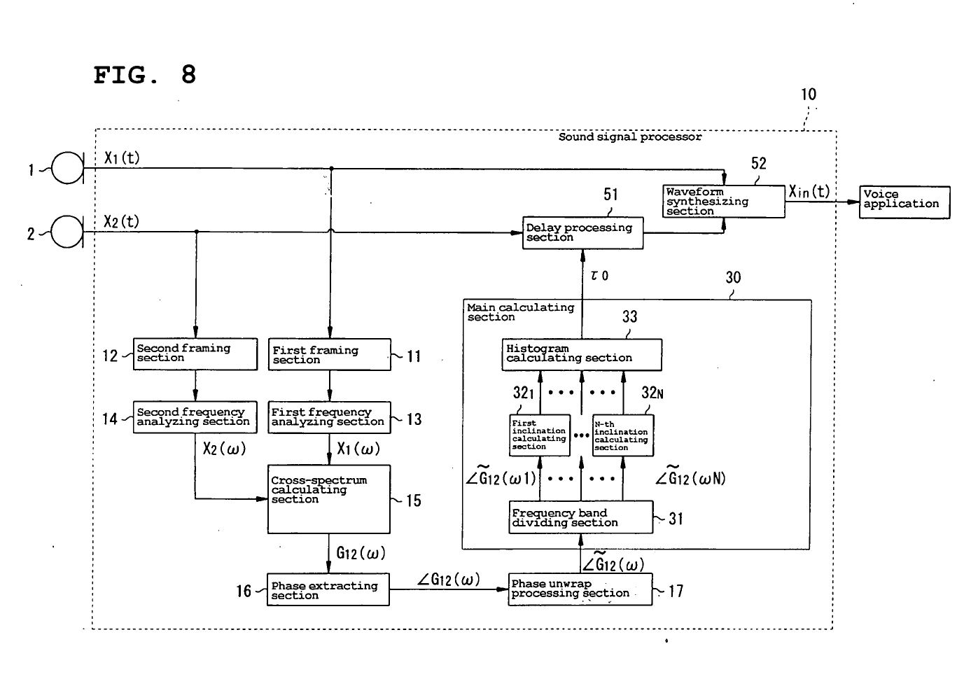

FIG. 8 shows a sound signal processor 10 according to the second preferred embodiment. In the second preferred embodiment, the sound signals picked up by the first and second microphones 1 and 2 are synthesized to be output to a voice application. To this end, the second preferred embodiment includes a delay processing section 51 and a waveform synthesizing section 52. The delay processing section 51 delays the sound signals from the second microphone 2 and outputs them to the waveform synthesizing section 52, and the waveform synthesizing section 52 synthesizes the sound signals from the first microphone 1 and the sound signals of the second microphone 2 input from and delayed by the delay processing section 51 and outputs them.

A phase difference is observed between the sound signals picked up by plural microphones, such as the first and second microphones 1 and 2, because of the difference between the distances from the sound source to the microphones 1 and 2. Therefore, in order to synthesize the sound signals picked up by plural microphones, such as the first and second microphones 1 and 2, a delay-and-sum processing is required, in which the difference between the arrival times of the sound signals from the sound source to the microphones 1 and 2 is corrected, the phases of those signals are synchronized, and thereafter the sound signals are added. Thus, the second preferred embodiment preferably includes the delay processing section 51 and the waveform synthesizing section 52 as described above.

In the foregoing first preferred embodiment (see FIG. 6), the mode calculating section 33C calculates the modal inclination τ0 from the histogram. In the second preferred embodiment, the delay processing section 51 performs delay processing based on the modal inclination τ0. A specific description is provided below.

As shown in FIG. 3 and (A) of FIG. 4, the phase components of a cross-spectrum have a constant inclination in voiced sections. This inclination indicates the delay time between the channels of the first and second microphones 1 and 2.

Utilizing this relationship, the delay processing section 51 performs delay processing based on the modal inclination τ0 calculated by the histogram calculating section 33. Specifically, as shown in FIG. 6, the mode calculating section 33C outputs the modal inclination τ0 to the delay processing section 51, and the delay processing section 51 performs delay processing based on the inputted modal inclination τ0.

τ0=x/n=2π·n₀/N [rad/point] (5)

wherein the units for x and n are respectively radian and frequency point (point), N represents the number of FFT points, and no represents the number of delay sampling points. From this relationship, the number of delay sampling points n₀ using the modal inclination τ0 as a variable can be obtained by the following equation (6):

n₀=τ0/(2π/N) [point] (6)

Then, using this number of delay sampling points no, the delay time t₀ is obtained by the following equation (7)

t₀=n₀/F_{S} (7)

wherein Fₛ represents the sampling frequency, for example, 16 kHz.

The delay processing section 51 delays the sound signals input from the second microphone 2 based on the obtained delay time to, and outputs them to the waveform synthesizing section 52.

The waveform synthesizing section 52 synthesizes the sound signals from the first microphone 1 and the sound signals from the second microphone 2, which are input from and delayed by the delay processing section 51, and outputs them.

Synthesized sound signals may also be obtained in the manner described below.

As previously described, X₂ (ω)e^{j}ω^{t0}, obtained by multiplying the frequency function X₂ by the delay term e^{j}ω^{t0}, is synchronized with the frequency function X₁, whereby the inverse Fourier transform of X₁(ω)+X₂(ω) e^{j}ω^{t0} is used as channel-synchronized-added sound. Utilizing this relationship, synthesized sound signals are obtained.

That is, first of all, the delay time τ₀ is used to obtain the channel-synchronized-added sound X₁(ω)+X₂(ω)e^{j}ω^{t0} on the frequency scale by the following equation (8). Note that the delay time to has the modal inclination τ0 as a variable as shown in the equations (6) and (7).

X₁(ω)+X₂(ω)e^{j}ω^{t0}={Re[X₁(ω)]+jIm[X₁(ω)]}+{Re[X₂(ω)](cos ωt₀+j sin ωt₀)+jIm[X₂(ω)](cos ωt₀+j sin ωt₀)} (8)

Here, the channel-synchronized-added spectrum is a complex spectrum composed of a real part and an imaginary part represented respectively as follows:

Re: Re[X₂(ω)] cos ωt₀−Im[X₂(ω)] sin ωt₀+Re[X₁(ω)]

Im: Re[X₂(ω)] sin ωt₀+Im[X₂(ω)] cos ωt₀+Re[X₁(ω)]

This processing is performed for each frame and then IFFT (inverse FFT) is performed for each frame, to obtain a frame string of the synchronized added sound.

The Overlap-add method is then applied to the obtained frame string, to obtain synchronized added sound, or synthetic signals of the sound signals of the first microphone 1 and the sound signals of the second microphone 2.

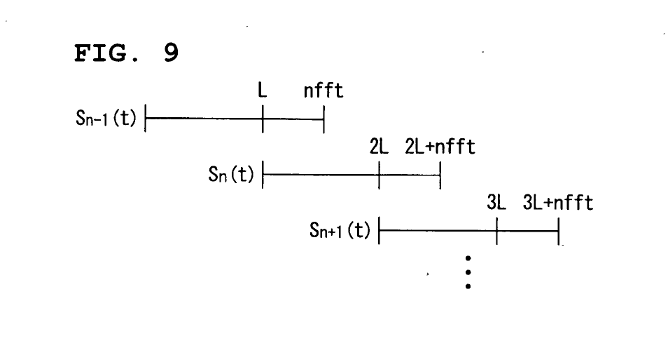

The Overlap-add method is a method in which input data strings sₙ(t) are added in overlapping relation as shown in FIG. 9. Here, sₙ(t) represents an n-th synthesized sound waveform frame. The symbol L in FIG. 9 represents a constant.

In the sound signal processor 10 constructed as described above, the delay processing section 51 delays the sound signals from the second microphone 2 and outputs them to the waveform synthesizing section 52, and the waveform synthesizing section 52 synthesizes the sound signals from the first microphone 1 and the sound signals from the second microphone 2 input from and delayed by the delay processing section 51 and outputs them.

The effects achieved by this construction are as follows.

As described in connection with the first preferred embodiment, the inclination of the phase of a cross-spectrum with respect to the frequency changes depending on the difference between the distances from the sound source to the first and second microphones 1 and 2. The delay time is estimated from this inclination of the phase of a cross-spectrum with respect to the frequency. The value actually used for the estimation is designated as modal inclination τ0. The use of the modal inclination τ0 in estimating the delay time ensures high accuracy of the estimated delay time.

Further, by synthesizing the sound signals of the first and second microphones based on the delay time as described above, high-quality synthesized sound signals are provided. For example, utilizing such synthesized sound signals, a voice recognition system performs voice recognition with a high recognition rate/low misrecognition rate, a cellular phone and a transceiver provide conversations in high-quality sound, and a broadcasting system provides high-quality broadcasting and recording.

As in the first preferred embodiment, the use of the modal inclination τ0 in the estimation of the delay time also provides outstanding voice input, even with environmental changes, such as a change in the mounting locations of the microphones, and movement of the sound source, such as movement or a change in posture of the speaker. In other words, outstanding voice input is achieved while maintaining a high degree of freedom in the locations of the microphones.

As described above, the aforementioned various effects are obtained even when using mountable microphones, which are compact and lightweight for easy mounting/removing, ensure short-distance sound pickup similar to close-talking microphones, and reduce the burden and discomfort when mounted to the user as compared to close-talking microphone headsets.

A voice recognition experiment with acoustic models was conducted using the synchronized added sound (synthesized sound signals) generated by a system to which the present preferred embodiment of the present invention was applied.

In this voice recognition experiment with acoustic models, first, acoustic models were prepared using learning data obtained from the synchronized added sound. The acoustic models prepared were as follows:

(1) Four collection-environment-dependent HMMs (hidden Markov models) prepared for each collection environment, and

(2) a collection-environment-independent HMM acquired through learning using sound from all the collection environments.

The collection environments were the same as above: in a soundproof room, in a car, in an office space, and on a sidewalk.

Then, a voice recognition experiment was conducted using the prepared acoustic models.

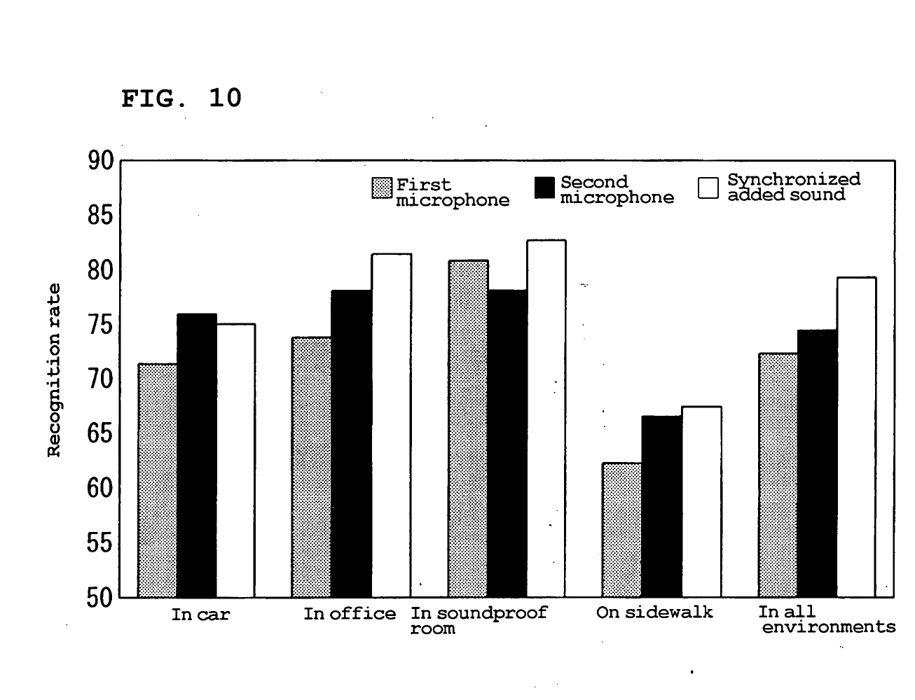

The recognition task was continuous voice recognition, and the data for evaluation (sound for evaluation) were different sounds from that used in the learning. FIG. 10 shows the results of the voice recognition experiment. The results of the recognition rate with the mono-channel sound from the first and second microphones 1 and 2 are also shown as comparison objects (conventional examples). The first and second microphones 1 and 2 were a glasses microphone and a chest microphone, respectively, for example. The glasses microphone refers to a microphone mounted to the frame of glasses.

As shown in FIG. 10, the recognition rate with the synchronized added sound obtained by the present preferred embodiment of the present invention exceeded the recognition rate with the mono-channel sound in a soundproof room, on a sidewalk, and in all the environments, except in a car. This demonstrated that the synchronized added sound generated by the system to which the present preferred embodiment of the present invention was applied was of high quality in actual environments.

A third preferred embodiment is described hereinafter.

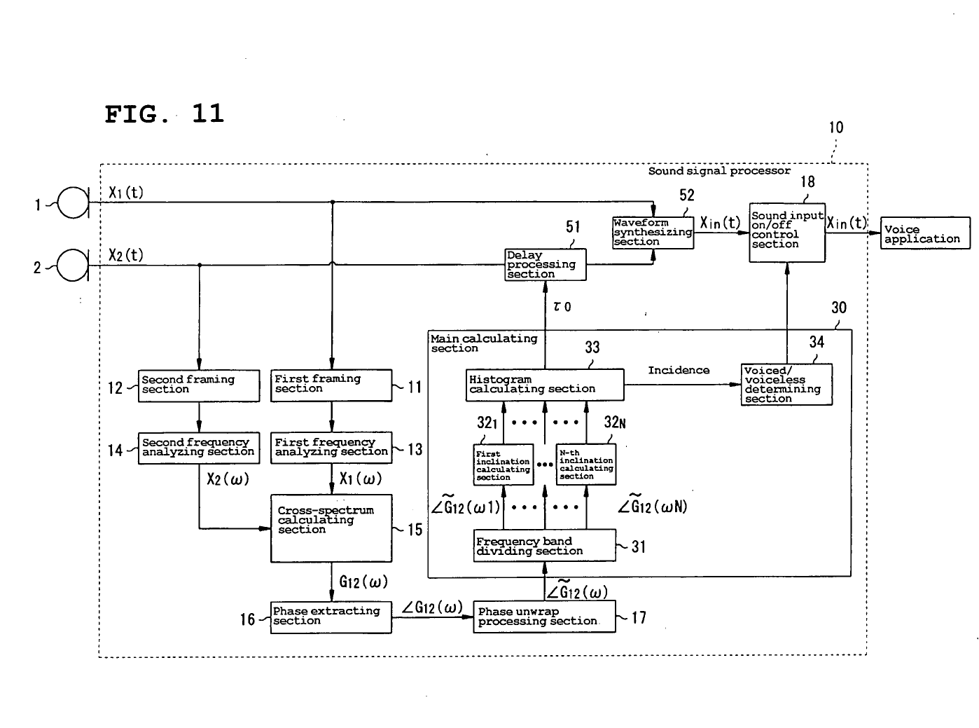

FIG. 11 shows a sound signal processor 10 according to the third preferred embodiment. The sound signal processor 10 of the third preferred embodiment is a combination of the sound signal processors 10 of the foregoing first and second preferred embodiments. That is, the sound signal processor 10 of the third preferred embodiment includes a voiced/voiceless determining section 34, a delay processing section 51, a waveform synthesizing section 52, and a sound input on/off control section 18.

Configured as described above, the sound signal processor 10 of the third preferred embodiment operates as follows. Note that those sections not specifically described operate in the same manner as in the sound signal processors 10 of the foregoing first and second preferred embodiments of the present invention.

The delay processing section 51 delays the sound signals of the second microphone 2 based on the modal inclination τ0 calculated by the histogram calculating section 33 (mode calculating section 33C). The waveform synthesizing section 52 synthesizes the sound signals of the second microphone 2 input from and delayed by the delay processing section 51 and the sound signals from the first microphone 1, and outputs the synthesized sound signals to the sound input on/off control section 18.

Meanwhile, the voiced/voiceless determining section 34 determines voiced and voiceless sections based on the incidence obtained by the histogram calculating section 33, and the sound input on/off control section 18 switches on and off to and not to output the sound signals (synchronized added sound signals) output from the waveform synthesizing section 52 based on the determination results.

Configured as described above, the sound signal processor 10 of the third preferred embodiment provides the effects achieved by the sound signal processors 10 of the foregoing first and second preferred embodiments.

That is, high-quality synthesized sound signals are generated, enabling accurate detection of speech sections contained therein. Further, even with variations in environmental conditions, such as a change in the mounting locations of the microphones, and movement of the sound source, such as movement or a change in posture of the speaker, outstanding voice input are achieved. In other words, outstanding voice input is achieved while maintaining a high degree of freedom in the locations of the microphones.

The descriptions of the preferred embodiments of the present invention have been provided above. The application of the present invention, however, is not limited to the foregoing preferred embodiments.

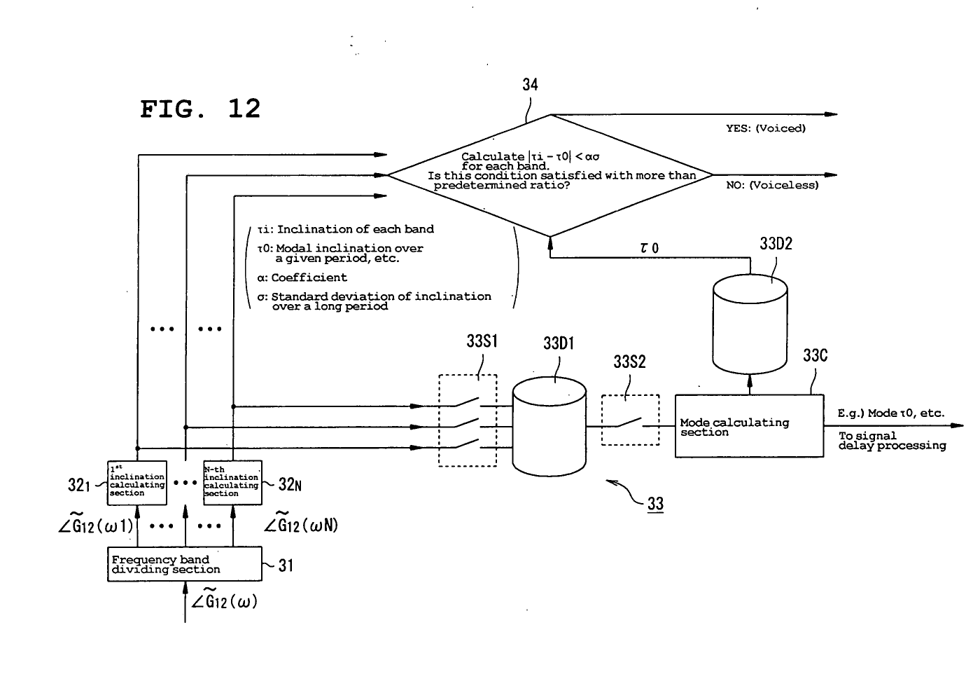

For example, as shown in FIG. 12, the voiced/voiceless determining section 34 compares the inclinations Ti calculated by the first through N-th inclination calculating sections 32₁ through 32_{N} and the modal inclination τ0, using the following inequality (9):

|τi−τ0|<ασ (9)

wherein α represents a coefficient, and σ represents a value physically included within the threshold used for the determination (inclination threshold) δ described previously. For example, the point of providing δ and ασ is to distinguish the difference between the effects in detecting voiced sections due to both values, namely δ as a constant and ασ as a variable progressively updated through real-time learning.

Since σ in ασ is updatable, the conditions for the determination of a voiced section may be made more strict to more effectively prevent incorrect determination of a voiceless section in quiet environments. Meanwhile, the conditions for the determination may be made less strict to permit more stable detection of a voiced section in environments with increased background noise. Assuming that a adapted for quiet environments is used in environments with background noise, which case is equivalent to the case when δ as a constant is used, there is a concern that a voiced section carrying overlapped noise and voice may not be identified properly.

In other words, δ as a constant functions effectively in the detection of voiced sections when used in environments similar to the conditions under which that value was set, while ασ as a variable functions effectively in the detection of voiced sections when used in a system intended to dynamically respond to environmental changes.

The strictness of the determination may be increased and reduced by changing the coefficient α.

In the foregoing preferred embodiments, the tendency of the inclinations of each band to be concentrated on a specific inclination was observed by creating histograms from these inclinations of each band. However, the tendency of the inclinations of each band to be concentrated on a specific inclination may be observed by another method.

Also, in the descriptions of the foregoing preferred embodiments, the detection target sound was speech sound produced by humans. However, the detection target sound may be sound produced by sources other than humans.

In the descriptions of the foregoing preferred embodiments, the first and second framing sections 11 and 12, first and second frequency analyzing sections 13 and 14, and cross-spectrum calculating section 15 preferably use a cross-spectrum phase detector for detecting the phase of a cross-spectrum between the sound signals inputted into plural microphones, the phase extracting section 16, phase unwrap processing section 17, frequency band dividing section 31, and first through N-th inclination calculating sections 32₁ through 32_{N} use an inclination detector for detecting the inclination of the phase of the cross-spectrum detected by the cross-spectrum phase detector with respect to the frequency, and the histogram calculating section 33 and voiced/voiceless determining section 34 use a speech sound detector for detecting a speech section contained in the sound picked up by the plural microphones based on the inclination with respect to the frequency detected by the inclination detector.

In addition, the histogram calculating section 33 and delay processing section 51 use a delay time detector for detecting the delay time between the sound signals picked up by the plural microphones based on the inclination with respect to the frequency detected by the inclination detector, and the waveform synthesizing section 52 uses a sound signal synthesizer for synthesizing the sound signals input into the plural microphones based on the delay time detected by the delay time detector.

Further, the sound signal processor 10 of the foregoing preferred embodiments may be applied to a voice recognition device. In this case, the voice recognition device includes a voice recognition processor for performing voice recognition processing of the sound signals contained in the speech section (speech sound) detected by the sound signal processor 10, in addition to the components of the sound signal processor 10 as described above.

Examples of voice recognition techniques include “VORERO” (trademark), a voice recognition technique proposed by Asahi Kasei Kabushiki Kaisha (see, for example, the following website: http://www.asahi-kasei.co.jp/vorero/jp/vorero/feature.html). The present invention may be applied to voice recognition devices using such voice recognition techniques.

Furthermore, the sound signal processor 10 of the foregoing preferred embodiments may be provided on a computer. And, the processing operation of the sound signal processor 10 as described above may be performed on a computer with a predetermined program. In this case, such a program may be designed to make the computer perform the process of detecting a target sound, the process including inputting detection target sounds output from a detection target sound source into plural microphones, detecting the phase of a cross-spectrum between the sound signals input into the plural microphones, detecting the inclination of the phase of the cross-spectrum with respect to the frequency due to the respective distances from the detection target sound source to the plural microphones, and, based on the inclination, detecting the target sound output from the detection target sound source and picked up by the plural microphones.

Alternatively, the program may be designed to make the computer perform a process of detecting the delay time in sound input, the process including inputting sounds output from a sound source into plural microphones, detecting the phase of a cross-spectrum between the sound signals input into the plural microphones, detecting the inclination of the phase of the cross-spectrum with respect to the frequency due to the respective distances from the sound source to the plural microphones, and, based on the inclination, detecting the delay time in sound reception from the sound source between the plural microphones.

The present invention provides a sound reception system which preferably uses mountable microphones and which efficiently operates even when environmental fluctuations occur.

While the present invention has been described with respect to preferred embodiments, it will be apparent to those skilled in the art that the disclosed invention may be modified in numerous ways and may assume many embodiments other than those specifically set out and described above. Accordingly, it is intended by the appended claims to cover all modifications of the invention which fall within the true spirit and scope of the invention.

1-20. (canceled)

21. A method for detecting a target sound, comprising the steps of:
inputting sounds output from a sound source into plural microphones;
detecting a phase of a cross-spectrum between sound signals input into the plural microphones;
detecting an inclination of the phase of the cross-spectrum with respect to a frequency due to respective distances from the sound source to the plural microphones; and
based on the inclination, determining whether the sound input into the plural microphones includes the target sound.

22. The method according to claim 21, wherein the target sound is human speech.

23. The method according to claim 21, further comprising the steps of:
dividing the frequency into a plurality of bands;
detecting the inclination of the phase for each of the plurality of bands; and
based on the detected inclinations of the phase of each of the plurality of bands, determining whether the sound input into the plural microphones includes the target sound.

24. The method according to claim 23, further comprising the steps of:
generating a histogram based on the detected inclinations of the phase of each of the plurality of bands; and
detecting an incidence from the histogram to determine whether the sound input into the plural microphones includes the target sound.

25. The method according to claim 23, further comprising the step of:
detecting the target sound when the detected inclinations of each of the plurality of bands are concentrated near a specific inclination.

26. The method according to claim 21, further comprising the steps of:
dividing the sound signals input into the plural microphones into predetermined time sections; and
detecting the phase of the cross-spectrum between the sound signals in each time section.

27. The method according to claim 21, wherein the plural microphones include at least two microphones adapted to be mounted in different positions.

28. The method according to claim 21, further comprising the step of, based on the inclination, detecting a delay time in signals input into the plural microphones from the sound source.

29. A method for determining a delay time in signal input, comprising the steps of:
inputting sounds output from a sound source into plural microphones;
detecting a phase of a cross-spectrum between sound signals input into the plural microphones;
detecting an inclination of the phase of the cross-spectrum with respect to a frequency due to respective distances from the sound source to the plural microphones; and
based on the inclination, determining the delay time in signal input of the sounds input into the plural microphones from the sound source.

30. The method according to claim 29, wherein in the step of determining the delay time, a predetermined modal inclination is used to determine the delay time.

31. The method according to claim 29, further comprising the steps of:
based on the determined delay time, synthesizing the sounds input into the first and second microphones; and
determining whether a target sound is present in the synthesized sound signals.

32. The method according to claim 31, wherein the target sound is human speech.

33. The method according to claim 31, further comprising the steps of:
dividing the frequency into a plurality of bands;
detecting the inclination of the phase for each of the plurality of bands; and
based on the detected inclinations of the phase of each of the plurality of bands, determining the delay time.

34. The method according to claim 33, further comprising the step of:
determining the delay time when the inclinations of each of the plurality of bands are concentrated near a specific inclination.

35. The method according to claim 31, further comprising the steps of:
dividing the sound signals input into the plural microphones into predetermined time sections; and
detecting the phase of the cross-spectrum between the sound signals in each time section.

36. A sound signal processor, comprising:
a cross-spectrum phase detector for detecting a phase of a cross-spectrum between sound signals input into plural microphones;
an inclination detector for detecting an inclination of the phase of the cross-spectrum detected by the cross-spectrum phase detector with respect to a frequency; and
a target sound detector for detecting whether the sound input into the plural microphones includes a target sound based on the inclination with respect to the frequency detected by the inclination detector.

37. The sound signal processor according to claim 36, wherein the target sound is human speech.

38. The sound signal processor according to claim 36, wherein the inclination detector divides the frequency of the phase of the cross-spectrum into a plurality of bands and detects inclinations of each of the plurality of bands, and the target sound detector detects whether the sound input into the plural microphones includes the target sound based on the inclinations of each of the plurality of bands detected by the inclination detector.

39. The sound signal processor according to claim 38, further comprising a histogram generator for generating a histogram based on the inclinations of the phase of each of the plurality of bands detected by the inclination detector, wherein the target sound detector detects an incidence from the histogram to determine whether the sound input into the plural microphones includes the target sound.

40. The sound signal processor according to claim 38, wherein the target sound detector detects the target sound when the inclinations of each of the plurality of bands are concentrated near a specific inclination.

41. The sound signal processor according to claim 36, wherein the inclination detector divides the sound signals input into the plural microphones into predetermined time sections and the target sound detector detects the phase of the cross-spectrum between the sound signals in each time section.

42. The sound signal processor according to claim 36, wherein the plural microphones include at least two microphones adapted to be mounted in different positions.

43. The sound signal processor according to claim 36, wherein the target signal detector detects a delay time in signals input into the plural microphones.

44. A sound signal processor for processing a sound output from a sound source and input into plural microphones, comprising:
a cross-spectrum phase detector for detecting a phase of a cross-spectrum between sound signals input into the plural microphones;
an inclination detector for detecting an inclination of the phase of the cross-spectrum detected by the cross-spectrum phase detector with respect to a frequency;
a delay time detector for detecting a delay time in the sound signals input into the plural microphones based on the inclination with respect to the frequency detected by the inclination detector.

45. The sound signal processor according to claim 44, further comprising a sound signal synthesizer for synthesizing the sound signals input into the plural microphones based on the delay time detected by the delay time detector.

46. The sound signal processor according to claim 45, further comprising a target sound detector for determining whether a target sound is present in the synthesized sound signals.

47. The sound signal processor according to claim 46, wherein the target sound is human speech.

48. The sound signal processor according to claim 44, wherein the inclination detector divides the phase of the cross-spectrum into to a plurality of bands and detects inclinations of each of the plurality of bands, and the delay time detector detects the delay time based on the inclinations of each of the plurality of bands detected by the inclination detector.

49. The sound signal processor according to claim 47, wherein the delay time detector detects the delay time when the inclinations of each of the plurality of bands are concentrated near a specific inclination.

50. The sound signal processor according to claim 47, wherein the inclination detector divides the sound signals input into the plural microphones into predetermined time sections and the delay time detector detects the delay time based on the cross-spectrum between the sound signals in each time section.

51. The sound signal processor according to claim 44, wherein the plural microphones include at least two microphones adapted to be mounted in different positions.

52. A voice recognition device for processing a speech sound output from a speech sound source and input into plural microphones, comprising:
a cross-spectrum phase detector for detecting a phase of a cross-spectrum between sound signals input into the plural microphones;
an inclination detector for detecting an inclination of the phase of the cross-spectrum detected by the cross-spectrum phase detector with respect to a frequency;
a speech sound detector for detecting whether the sound signals input into the plural microphones includes the speech sound based on the inclination with respect to the frequency detected by the inclination detector; and
a voice recognition processor for performing voice recognition processing of the speech sound detected by the speech sound detector.

53. The voice recognition device according to claim 52, wherein
the inclination detector divides the frequency of the phase of the cross-spectrum into a plurality of bands and detects inclinations of each of the plurality of bands; and
the speech sound detector detects whether the sound signals input into the plural microphones includes the speech sound based on the inclinations of each of the plurality of bands detected by the inclination detector.

54. A voice recognition device for processing a speech sound output from a speech sound source and input into plural microphones, comprising:
a cross-spectrum phase detector for detecting a phase of a cross-spectrum between sound signals input into the plural microphones;
an inclination detector for detecting an inclination of the phase of the cross-spectrum detected by the cross-spectrum phase detector with respect to a frequency;
a delay time detector for detecting a delay time in the sound signals input into the plural microphones based on the inclination with respect to the frequency detected by the inclination detector;
a sound signal synthesizer for synthesizing the sound signals input into the plural microphones based on the delay time detected by the delay time detector;
a speech sound detector for detecting whether the synthesized sound signals synthesized by the sound signal synthesizer include the speech sound based on the inclination with respect to the frequency detected by the inclination detector; and
a voice recognition processor for performing voice recognition processing of the speech sound detected by the speech sound detector.

55. The voice recognition device according to claim 54, wherein
the inclination detector divides the phase of the cross-spectrum into a plurality of bands and detects inclinations of each of the plurality of bands;
the delay time detector detects the delay time based on the inclinations of each of the plurality of bands detected by the inclination detector; and
the speech sound detector detects the speech sound based on the inclinations of each of the plurality of bands detected by the inclination detector.

56. A program for making a computer perform a process of detecting a target sound, the process comprising the steps of:
inputting sounds output from a sound source into plural microphones;
detecting a phase of a cross-spectrum between sound signals input into the plural microphones;
detecting an inclination of the phase of the cross-spectrum with respect to a frequency due to respective distances from the sound source to the plural microphones; and
based on the inclination, determining whether the sound input into the plural microphones includes the target sound.

57. A program for making a computer perform a process of detecting a delay time in sound input, the process comprising the steps of:
inputting sounds output from a sound source into plural microphones;
detecting a phase of a cross-spectrum between sound signals input into the plural microphones;
detecting an inclination of the phase of the cross-spectrum with respect to a frequency due to respective distances from the sound source to the plural microphones; and
based on the inclination, determining a delay time in signals input into the plural microphones.
